(19) United States
(12) Patent Application Publication
(10) Pub. No.: US 2025/0294641 A1
(43) Pub. Date: Sep. 18, 2025

(54) METHOD FOR SYSTEM MESSAGE PROCESSING, COMMUNICATION DEVICE, AND NON-TRANSITORY COMPUTER-READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/860,121

(22) PCT Filed: Apr. 29, 2022
(86) PCT No.: PCT/CN2022/090613

§ 371 Date: Oct. 25, 2024

(51) Int. Cl. H04W 76/40; H04B 7/06

(52) U.S. Cl. CPC H04W 76/40; H04B 7/06968

(57) ABSTRACT

A method for system message processing, performed by a base station, includes: sending a system message requested by a terminal on a partial synchronization signal/physical broadcast channel (SS/PBCH) beam.

### CROSS REFERENCE TO RELATED APPLICATIONS

The present application is a U.S. National Stage of International Application No. PCT/CN2022/090613, filed on Apr. 29, 2022, all contents of which are incorporated herein by reference in their entireties for all purposes.

### TECHNICAL FIELD

The present disclosure relates to the field of wireless communication technology, but is not limited to the field of wireless communication technology, and in particular, to a method and apparatus system message processing, a communication device, and a storage medium.

### BACKGROUND

In a radio resource (NR), system information (SI) may be divided into two types according to the broadcast state, the first type of SI is periodically broadcasted, and the second type of SI is non-periodically broadcasted. For the terminal in the connected state, if the terminal needs to obtain the second type of SI, the terminal may initiate a request through radio resource control (RRC) layer signaling.

If the network side has a common search space configured for receiving of other system information on the active bandwidth part (BWP) for operations of the terminal, the base station may directly broadcast the requested other system information in the common search space of the active BWP, and the terminal may receive the system message.

Both the requested system message and the sent and periodically broadcasted system message are broadcasted by the base station.

### SUMMARY

According to a first aspect of the embodiments of the present disclosure, there is provided a method for system message processing, which is performed by a base station, and the method includes:
sending a system message requested by a terminal on a partial synchronization signal/physical broadcast channel (SS/PBCH) beam.

According to a second aspect of the embodiments of the present disclosure, there is provided a method for system message processing, which is performed by a terminal, and the method includes:
receiving a system message requested by the terminal on a partial SS/PBCH beam.

According to a third aspect of the embodiments of the present disclosure, there is provided a communication device, including a processor, a transceiver, a memory, and an executable program stored in the memory and capable of being run by the processor, where when the processor runs the executable program, the method for system message processing provided in the first aspect or the second aspect is performed.

According to a fourth aspect of the embodiments of the present disclosure, there is provided a non-transitory computer-readable storage medium, where the non-transitory computer- readable storage medium stores an executable program: and after the executable program is executed by a processor, the method for system message processing provided in the first aspect or the second aspect is able to be implemented.

### BRIEF DESCRIPTION OF THE DRAWINGS

The accompanying drawings here, which are incorporated in and constitute a part of the description, illustrate embodiments consistent with the present invention, and together with the description, serve to explain the principles of the embodiments of the present invention.

FIG. 1 is a schematic structural diagram of a wireless communication system shown according to some embodiments of the present disclosure:

FIG. 2 is a schematic flowchart of a method for system message processing shown according to some embodiments of the present disclosure:

FIG. 3 is a schematic flowchart of a method for system message processing shown according to some embodiments of the present disclosure:

FIG. 4 is a schematic flowchart of a method for system message processing shown according to some embodiments of the present disclosure:

FIG. 5 is a schematic flowchart of a method for system message processing shown according to some embodiments of the present disclosure:

FIG. 6 is a schematic structural diagram of an apparatus for system message processing shown according to some embodiments of the present disclosure:

FIG. 7 is a schematic structural diagram of an apparatus for system message processing shown according to some embodiments of the present disclosure:

FIG. 8 is a schematic structural diagram of a terminal shown according to some embodiments of the present disclosure:

FIG. 9 is a schematic structural diagram of a communication device shown according to some embodiments of the present disclosure.

### DETAILED DESCRIPTION

Example embodiments will now be described in detail, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure.

Terms used in the embodiments of the present disclosure are merely for the purpose of describing particular embodiments, and are not intended to limit the embodiments of the present disclosure. As used here, the singular forms “a”, “an” and “the” are intended to include the plural forms as well, unless the context clearly indicates other meanings. It should also be understood that the term “and/or” as used here refers to and includes any or all possible combinations of one or more associated listed items.

It should be understood that although the terms of first, second, third, etc., may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information: and similarly, the second information may also be referred to as first information. Depending on the context, the word “if” as used here may be interpreted as “at the time that . . .” or “when . . .” or “in response to determining . . .”.

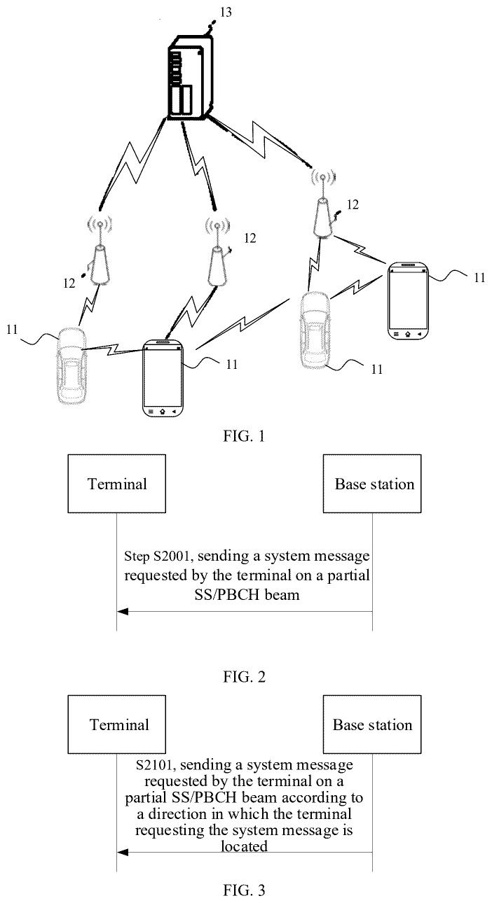

Referring to FIG. 1, FIG. 1 shows a schematic structural diagram of a wireless communication system provided according to an embodiment of the present disclosure. As shown in FIG. 1, the wireless communication system is a communication system based on a cellular mobile communication technology, and the wireless communication system may include a plurality of terminals, i.e., UE 11 and several access devices 12 in the drawing.

Among them, UE 11 may be a device that provides voice and/or data connectivity to a user. UE 11 may communicate with one or more core networks via a radio access network (RAN). UE 11 may be Internet of Things UE, such as a sensor device, a mobile phone (or referred to as a “cellular” phone), and a computer having Internet of Things UE; for example, it may be a fixed, portable, pocket-sized, hand-held, computer-built-in, or vehicle-mounted device, such as a station (STA), a subscriber unit, a subscriber station, a mobile station, a mobile, a remote station, an access point, a remote terminal, an access terminal, a user terminal, a user agent, a user device, or user equipment (UE). Alternatively, UE 11 may be a device of an unmanned aerial vehicle. Alternatively, UE 11 may be a vehicle-mounted device; for example, it may be a trip computer having a wireless communication function, or a wireless communication device externally connected to a trip computer. Alternatively, UE 11 may be a roadside device: for example, it may be a street lamp, a signal lamp, another roadside device, or the like, with a wireless communication function.

Access device 12 may be a network side device in a wireless communication system. Among them, the wireless communication system may be a 4th generation mobile communication (4G) system, a long term evolution (LTE) system. Alternatively, the wireless communication system may be a 5G system, which is also referred to as a new radio (NR) system, or a 5G NR system. Alternatively, the wireless communication system may be a next-generation system of the 5G system, or an MTC system, where the access network in the 5G system may be referred to as a new generation-radio access network (NG-RAN).

Among them, the access device 12 may be an evolved access device (eNB) used in the 4G system. Alternatively, the access device 12 may also be an access device (gNB) that adopts a centralized distributed architecture in the 5G system. When the access device 12 adopts a centralized distributed architecture, it usually includes a central unit (CU) and at least two distributed units (DU). A protocol stack for the packet data convergence protocol (PDCP) layer, the radio link control (RLC) layer, and the media access control (MAC) layer is provided in the central unit; and, a protocol stack for the physical (PHY) layer is provided in the distributed unit. The specific implementation of the access device 12 is not limited in the embodiments of the present disclosure.

A wireless connection may be established between the access device 12 and the UE 11 through a wireless air interface. In different embodiments, the wireless air interface is a wireless air interface based on the 4th generation mobile communication network technology (4G) standard. Alternatively, the wireless air interface is a wireless air interface based on the 5th generation mobile communication network technology (5G) standard: for example, the wireless air interface is a new radio. Alternatively, the wireless air interface may also be a wireless air interface based on a next-generation of 5G mobile communication network technology standard.

As shown in FIG. 2, according to embodiments of the present disclosure, there is provided a method for system message processing, where the method is performed by a base station, and the method includes the following step.

In step S2001, a system message requested by a terminal is a sent on a partial SS/PBCH beam. In the embodiments of the present disclosure, the method may be performed by a base station. The base station includes, but is not limited to, an eNB and/or a gNB.

Among them, an SS/PBCH is a synchronization broadcast block broadcasted by a base station. The SS/PBCH may include a primary synchronization signal, a secondary synchronization signal, and a PBCH transmission.

In the embodiments of the present disclosure, a SS/PBCH beam is a beam carrying an SS/PBCH. If the base station uses a beam to communicate with the terminal, the base station generally sends the SS/PBCH on various beams in a cell, so that the terminal located at different positions in the cell relative to the base station can establish synchronization with the base station based on the monitored SS/PBCH, and access the base station.

The partial SS/PBCH beam is a beam carrying an SS/PBCH and transmitted by a base station in a specific direction in a cell. The specific direction may include a direction in which the terminal is located.

For example, it needs M beams for the base station to sends the SS/PBCH in the cell in a beam scanning manner; however, the base station may send a system message requested by the terminal on N SS/PBCH beams, where N is less than M.

The terminal requesting the system message is only located at one position of the cell at one moment. Therefore, it does not need to transmit the system message requested by the terminal on all SS/PBCH beams in the cell, but only needs to send the requested system message on a partial SS/PBCH beam, so that unnecessary broadcast for the requested system message can be reduced, and the time-frequency domain resource consumed by the requested system message may be reduced.

As shown in FIG. 3, according to embodiments of the present disclosure, there is provided a method for system message processing, where the method is performed by a base station, and the method includes the following step.

In step S2101, a system message requested by a terminal is sent on a partial SS/PBCH beam according to a direction in which the terminal requesting the system message is located.

There are a plurality of manners of determining the direction in which the terminal is located: for example, at least one of the following manners may be included.

The direction in which the terminal is located is determined according to an uplink transmission performed by a terminal using a beam.

The direction in which the terminal is located is determined according to position information reported by the terminal.

Certainly, the foregoing is merely examples of determining the direction in which the terminal is located by the base station.

In the embodiments of the present disclosure, according to the direction in which the terminal requesting the system message is located, the system message requested by the terminal may be sent on one or more SS/PBCH beams with a transmission direction adapted to the direction in which the terminal is located, so that on one hand, it is implemented that the system message is sent to the terminal, and on the other hand, the number of SS/PBCH beams for sending the system message requested by the terminal is reduced.

As shown in FIG. 4, according to embodiments of the present disclosure, there is provided a method for system message processing, where the method is performed by a base station, and the method includes the following step.

In step S2201, a request message sent by a terminal in a connected state on a first beam is received, where the request message is used to request the system message.

Among them, the connected state is an abbreviation of an RRC connected state. If the terminal is in the connected state, an RRC connection is established between the terminal and the base station. In this case, the terminal may request the system message from the base station through the RRC connection. For example, the terminal may request the system message from the base station through an RRC message.

For example, the RRC message carries request information that the terminal requests the system message and/or a message identification of the requested system message. The message identification may be used by the base station to determine the specific system message block currently requested by the terminal. The system message requested by the terminal is a system message that may not be periodically broadcasted by the base station.

In some embodiments, the system information is divided into minimum system information (minimum SI) and other system information (other SI), and the other system information includes all system information that is not broadcasted in the minimum system information. The other system information may be broadcasted and sent to a terminal in the RRC idle state or an inactive state, or may be unicast-sent to a terminal in the connected state through RRC signaling.

As shown in FIG. 4, according to embodiments of the present disclosure, there is provided a method for system message processing, where the method is performed by a base station, and the method includes following steps.

In step S2201, a request message sent by a terminal in a connected state on a first beam is received, where the request message is used to request a system message.

In step S2202, the system message requested by the terminal is sent on a partial SS/PBCH beam according to a direction of a first beam for the terminal to send the request message.

The request message is an uplink transmission of the terminal.

The first beam is an uplink beam for the uplink transmission sent by the terminal. When receiving the request of the terminal on the first beam, the base station may determine, according to the beam direction of the first beam, a direction in which the terminal is located relative to the base station, so as to further determine which SS/PBCH beams to send the system message on that causes the terminal to successfully receive the system message.

For example, in some cases, the uplink beam and the downlink beam satisfy the beam consistency. In this case, a second beam that satisfies the beam consistency with the first beam may be determined based on the first beam. The system message requested by the terminal is sent by using the second beam for sending the SS/PBCH.

For another example, considering the mobility of the terminal, in order to improve the success receiving probability of the terminal as much as possible, in addition to sending the system message requested by the terminal on the second beam for sending the SS/PBCH, the system message requested by the terminal may also be sent on a third beam for sending the SS/PBCH. The third beam is one or two beams with a beam direction adjacent to the beam direction of the second beam.

In some embodiments, the step S2001 of sending the system message requested by the terminal on the partial SS/PBCH beam may include:
sending the system message requested by the terminal on an SS/PBCH beam having a predetermined type of quasi co-location (QCL) relationship with an uplink reference signal beam corresponding to a physical uplink shared channel (PUSCH) for the terminal to send the request message.

In some embodiments, the uplink reference signal beam is a beam for sending an uplink reference signal. The uplink reference signal includes, but is not limited to, a demodulation reference signal (DMRS) and a sounding reference signal (SRS). The beam for transmitting the PUSCH is the same as the uplink reference signal beam.

If the SRS beam of the base station has a predetermined type of QCL relationship with a certain SS/PBCH beam, it indicates that the large-scale parameters of the SRS beam and the SS/PBCH beam are consistent with each other, and the large-scale parameters being consistent with each other indicates that the channel conditions are approximately the same, thus the system message requested by the terminal may be sent on the corresponding beam, and the terminal may successfully receive the system message.

In some embodiments, the large-scale parameters may include a latency extension, an average latency, a Doppler extension, a Doppler offset, an average gain, and/or a spatial reception parameter, etc.

Although the difference in the spatial position or angle of each station is transparent to the terminal and the coordinated multiple point transmission (CoNP) operation, the influence of the spatial difference on the channel large-scale parameters is an important factor that needs to be considered when the terminal performs channel estimation and reception detection.

In some embodiments, the step S2001 of sending the system message requested by the terminal on the partial synchronization signal/physical broadcast channel (SS/PBCH) beam may include at least one of the following:
sending the system message requested by the terminal on an SS/PBCH beam having a predetermined type of quasi co-location (QCL) relationship with a transmission configuration indication (TCI) of a physical downlink control channel (PDCCH) configured for the terminal; sending the system message requested by the terminal on an SS/PBCH beam having a predetermined type of QCL relationship with a transmission configuration indication (TCI) of a PDCCH activated by the terminal; or
sending the system message requested by the terminal on an SS/PBCH beam having a predetermined type of QCL relationship with a TCI of a PDSCH configured for the terminal. TCI is a type of information that indicates the beam direction. When the base station configures the PDCCH for the terminal, if the base station and the terminal use a beam for communication, a corresponding TCI may be determined. When configuring the TCI of the PDCCH for the terminal, the base station needs to refer to the direction in which the terminal is located. Therefore, the terminal may send the system message requested by the terminal by using an SS/PBCH beam having a predetermined type of QCL relationship with the TCI of the PDCCH. In some cases, the base station may configure a plurality of TCIs of PDCCH for the terminal, in which only a part of or one TCI of PDCCH is activated. Finally, PDCCH transmission may be performed by using a beam corresponding to the activated TCI. Therefore, in the embodiments of the present disclosure, the SS/PBCH beam for sending the system message requested by the terminal may also be determined according to the TCI of PDCCH activated by the terminal.

The PDSCH may be a channel for the base station to send downlink data to the terminal. When performing configuration of TCI for PDSCH, it is also needed to ensure that the terminal can receive the system message. An SS/PBCH beam having a predetermined type of QCL relationship with the TCI configured for the PDSCH may be selected to send the system message requested by the terminal.

In some embodiments, the predetermined type of QCL relationship includes a type D of QCL relationship.

If there is a type D of QCL relationship, it indicates that the spatial reception parameters are consistent with each other, thus it can be ensured that the two corresponding downlink beams point to the same direction, or the corresponding uplink beam and downlink beam have the beam consistency.

In some embodiments, an active bandwidth part (BWP) of the terminal is configured with a common search space for receiving other system messages.

The active BWP of the terminal is an active BWP configured by the base station for the terminal to use.

For example, the active BWP may be a downlink BWP activated by the terminal.

If the activated BWP of the terminal is configured with a common search space for other system messages, it indicates that the system message requested by the terminal may be sent in the common search space.

In the embodiments of the present disclosure, after sending the request message for the system message, it may wait to receive the requested system message in the common search space. As shown in FIG. 5, according to embodiments of the present disclosure, there is provided a method for system message processing, where the method is performed by a terminal, and the method includes the following step.

In step S5001, a system message requested by a terminal is sent on a partial SS/PBCH beam. Among them, an SS/PBCH is a synchronization broadcast block broadcasted by a base station. The SS/PBCH may include a primary synchronization signal, a secondary synchronization signal, and a PBCH transmission.

In the embodiments of the present disclosure, a SS/PBCH beam is a beam carrying an SS/PBCH. If the base station uses a beam to communicate with the terminal, the base station generally sends the SS/PBCH on various beams in a cell, so that the terminal located at different positions in the cell relative to the base station can establish synchronization with the base station based on the monitored SS/PBCH, and access the base station

The partial SS/PBCH beam is a beam carrying an SS/PBCH and transmitted by a base station in a specific direction in a cell. The specific direction may include a direction in which the terminal is located.

For example, it needs M beams for the base station to sends the SS/PBCH in the cell in a beam scanning manner: however, the base station may send a system message requested by the terminal on N SS/PBCH beams, where N is less than M.

The terminal requesting the system message is only located at one position of the cell at one moment. Therefore, it does not need to transmit the system message requested by the terminal on all SS/PBCH beams in the cell, but only needs to send the requested system message on a partial SS/PBCH beam, so that unnecessary broadcast for the requested system message can be reduced, and the time-frequency domain resource consumed by the requested system message may be reduced.

In some embodiments, receiving the system message requested by the terminal on the partial SS/PBCH beam may include:
receiving the system message requested by the terminal on the partial SS/PBCH beam according to a direction in which the terminal is located.

There are a plurality of manners of determining the direction in which the terminal is located: for example, at least one of the following manners may be include.

The direction in which the terminal is located is determined according to an uplink transmission performed by a terminal using a beam.

The direction in which the terminal is located is determined according to position information reported by the terminal.

Certainly, the foregoing is merely examples of determining the direction in which the terminal is located by the base station.

In the embodiments of the present disclosure, according to the direction in which the terminal requesting the system message is located, the system message requested by the terminal may be sent on one or more SS/PBCH beams with a transmission direction adapted to the direction in which the terminal is located, so that on one hand, it is implemented that the system message is sent to the terminal, and on the other hand, the number of SS/PBCH beams for sending the system message requested by the terminal is reduced.

In some embodiments, the method further includes:
sending, by the terminal in a connected state, a request message on a first beam, where the request message is used to request the system message.

Among them, if the terminal is in the connected state, an RRC connection is established between the terminal and the base station. In this case, the terminal may request the system message from the base station through the RRC connection. For example, the terminal may request the system message from the base station through an RRC message.

For example, the RRC message carries request information that the terminal requests the system message and/or a message identification of the requested system message. The message identification may be used by the base station to determine the specific system message block currently requested by the terminal. The system message requested by the terminal is a system message that may not be periodically broadcasted by the base station.

In some embodiments, other system information includes all system information that is not broadcasted in the minimum system information. The other system information may be broadcasted and sent to a terminal in the RRC idle state or an inactive state, or may be unicast-sent to a terminal in the connected state through RRC signaling.

In some embodiments, the step S5001 of receiving the system message requested by the terminal on the partial SS/PBCH beam may include:
receiving the system message requested by the terminal on the partial SS/PBCH beam according to a direction of a first beam for the terminal to send the request message.

The request message is an uplink transmission of the terminal.

The first beam is an uplink beam for the uplink transmission sent by the terminal. When receiving the request of the terminal on the first beam, the base station may determine, according to the beam direction of the first beam, a direction in which the terminal is located relative to the base station, so as to further determine which SS/PBCH beams to send the system message on that causes the terminal to successfully receive the system message.

For example, in some cases, the uplink beam and the downlink beam satisfy the beam consistency. In this case, a second beam that satisfies the beam consistency with the first beam may be determined based on the first beam. The system message requested by the terminal is sent by using the second beam for sending the SS/PBCH.

For another example, considering the mobility of the terminal, in order to improve the success receiving probability of the terminal as much as possible, in addition to sending the system message requested by the terminal on the second beam for sending the SS/PBCH, the system message requested by the terminal may also be sent on a third beam for sending the SS/PBCH. The third beam is one or two beams with a beam direction adjacent to the beam direction of the second beam.

In some embodiments, the step S5001 of receiving the system message requested by the terminal on an SS/PBCH beam includes:
receiving the system message requested by the terminal on an SS/PBCH beam having a predetermined type of QCL relationship with an uplink reference signal corresponding to a PUSCH for the terminal to send the request message.

In some embodiments, the uplink reference signal beam is a beam for sending an uplink reference signal. The uplink reference signal includes, but is not limited to, a sounding reference signal. The beam for transmitting the PUSCH is the same as the uplink reference signal beam.

If the SRS beam of the base station has a predetermined type of QCL relationship with a certain SS/PBCH beam, it indicates that the large-scale parameters of the SRS beam and the SS/PBCH beam are consistent with each other, and the large-scale parameters being consistent with each other indicates that the channel conditions are approximately the same, thus the system message requested by the terminal may be sent on the corresponding beam, and the terminal may successfully receive the system message.

In some embodiments, the large-scale parameters may include a latency extension, an average latency, a Doppler extension, a Doppler offset, an average gain, and/or a spatial reception parameter, etc.

Although the difference in the spatial position or angle of each station is transparent to the terminal and the coordinated multiple point transmission operation, the influence of the spatial difference on the channel large-scale parameters is an important factor that needs to be considered when the terminal performs channel estimation and reception detection.

In some embodiments, receiving the system message requested by the terminal on the partial synchronization signal/physical broadcast channel (SS/PBCH) beam includes at least one of the following:
receiving the system message requested by the terminal on an SS/PBCH beam having a predetermined type of QCL relationship with a transmission configuration indication (TCI) of a PDCCH configured for the terminal;
receiving the system message requested by the terminal on an SS/PBCH beam having a predetermined type of QCL relationship with a TCI of a PDCCH activated by the terminal; or receiving the system message requested by the terminal on an SS/PBCH beam having a predetermined type of QCL relationship with a TCI of a PDSCH configured for the terminal. TCI is a type of information that indicates the beam direction. When the base station configures the PDCCH for the terminal, if the base station and the terminal use a beam for communication, a corresponding TCI may be determined. When configuring the TCI of the PDCCH for the terminal, the base station needs to refer to the direction in which the terminal is located. Therefore, the terminal may send the system message requested by the terminal by using an SS/PBCH beam having a predetermined type of QCL relationship with the TCI of the PDCCH. In some cases, the base station may configure a plurality of TCIs of PDCCH for the terminal. in which only a part of or one TCI of PDCCH is activated. Finally, PDCCH transmission may be performed by using a beam corresponding to the activated TCI. Therefore, in the embodiments of the present disclosure, the SS/PBCH beam for sending the system message requested by the terminal may also be determined according to the TCI of PDCCH activated by the terminal.

The PDSCH may be a channel for the base station to send downlink data to the terminal. When performing configuration of TCI for PDSCH, it is also needed to ensure that the terminal can receive the system message. An SS/PBCH beam having a predetermined type of QCL relationship with the TCI configured for the PDSCH may be selected to send the system message requested by the terminal.

In some embodiments, the predetermined type of QCL relationship includes a type D of QCL relationship.

If there is a type D of QCL relationship, it indicates that the spatial reception parameters are consistent with each other, thus it can be ensured that the two corresponding downlink beams point to the same direction, or the corresponding uplink beam and downlink beam have the beam consistency.

In some embodiments, an active bandwidth part (BWP) of the terminal is configured with a common search space for receiving the system message requested on demand.

The active BWP of the terminal is an active BWP configured by the base station for the terminal to use.

For example, the active BWP may be a downlink BWP activated by the terminal. If the activated BWP of the terminal is configured with a common search space for other system messages, it indicates that the system message requested by the terminal may be sent in the common search space.

In the embodiments of the present disclosure, after sending the request message for the system message, it may wait to receive the requested system message in the common search space. According to the method for system message processing provided in the embodiments of the present disclosure, the base station only needs to broadcast the requested SI on the SS/PBCH beam in the direction where the terminal is located, and does not need to broadcast the SI in all SS/PBCH beam directions, so that unnecessary broadcast for the requested system message can be reduced, and time-frequency domain resources consumed by the requested system message can be reduced.

In some embodiments, when the terminal in the connected state requests certain system information (SI), since the base station knows the beam direction of the terminal, the base station only needs to broadcast the requested SI on the SS/PBCH beam in the direction in which the terminal is located, and does not need to broadcast the SI on all SS/PBCH beams.

For example, the base station sends the SI on a partial SS/PBCH beam.

For example, the SI is SI requested by the terminal in the RRC connected state to be sent.

For example, the SI is SI in a non-broadcast state.

For example, the activated BWP of the terminal in the connected state has a search space for receiving other system information.

For example, the base station may determine by itself to select a partial SS/PBCH beam from the actually transmitted SS/PBCH beams to transmit the SI. For example, the base station may select a corresponding partial SS/PBCH beam according to the direction of the terminal.

For example, the partial SS/PBCH beam at least includes an SS/PBCH beam having a type D of QCL relationship with a TCI state of a PDCCH configured for the terminal in the connected state.

For example, the partial SS/PBCH beam at least include an SS/PBCH beam having a type D of QCL relationship with a TCI state of a currently activated PDCCH for the terminal in the connected state.

As shown in FIG. 6, according to embodiments of the present disclosure, there is provided an apparatus for system message processing, where the apparatus includes a first sending module 601.

The first sending module 601 is configured to send a system message requested by a terminal on a partial synchronization signal/physical broadcast channel (SS/PBCH) beam.

In some embodiments, the first sending module 601 is configured to send the system message requested by the terminal on the partial synchronization signal/physical broadcast channel (SS/PBCH) beam according to a direction in which the terminal is located, when sending the system message requested by the terminal on the partial synchronization signal/physical broadcast channel (SS/PBCH) beam.

In some embodiments, the apparatus further includes a first receiving module 600.

The first receiving module 600 is configured to receive a request message sent by the terminal in a connected state on a first beam, where the request message is used to request the system message.

In some embodiments, the first sending module is configured to send the system message requested by the terminal on the partial synchronization signal/physical broadcast channel (SS/PBCH) beam according to a direction of the first beam for the terminal to send the request message, when sending the system message requested by the terminal on the partial synchronization signal/physical broadcast channel (SS/PBCH) beam.

In some embodiments, the first sending module 601 is configured to send the system message requested by the terminal on an SS/PBCH beam having a predetermined type of quasi co-location (QCL) relationship with an uplink reference signal beam corresponding to a physical uplink shared channel (PUSCH) for the terminal to send the request message, when sending the system message requested by the terminal on the partial synchronization signal/physical broadcast channel (SS/PBCH) beam.

In some embodiments, when sending the system message requested by the terminal on the partial synchronization signal/physical broadcast channel (SS/PBCH) beam, the first sending module 601 is configured to at least one of the following:
send the system message requested by the terminal on an SS/PBCH beam having a predetermined type of quasi co-location (QCL) relationship with a transmission configuration indication (TCI) of a physical downlink control channel (PDCCH) configured for the terminal;
send the system message requested by the terminal on an SS/PBCH beam having a predetermined type of quasi co-location (QCL) relationship with a transmission configuration indication (TCI) of a PDCCH activated by the terminal; or
send the system message requested by the terminal on an SS/PBCH beam having a predetermined type of quasi co-location (QCL) relationship with a transmission configuration indication (TCI) of a physical downlink shared channel (PDSCH) configured for the terminal In some embodiments, the predetermined type of QCL relationship includes a type D of QCL relationship.

In some embodiments, an active bandwidth part (BWP) of the terminal is configured with a common search space for receiving other system information and a system message requested on demand.

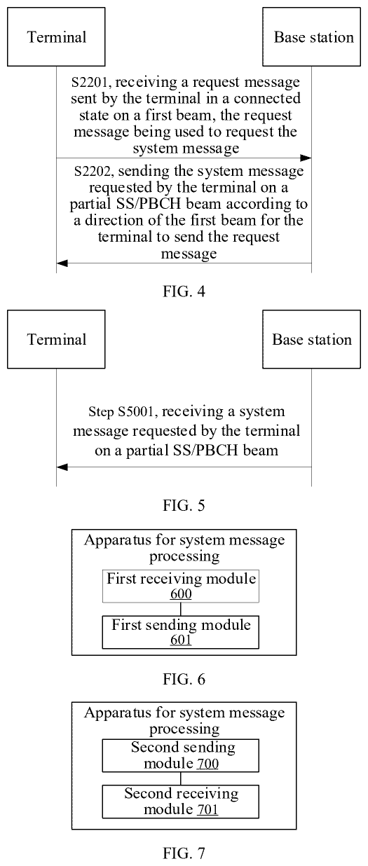

As shown in FIG. 7, according to embodiments of the present disclosure, there is provided an apparatus for system message processing, where the apparatus includes a second receiving module 701.

The second receiving module 701 is configured to receive a system message requested by a terminal on a partial synchronization signal/physical broadcast channel (SS/PBCH) beam.

In some embodiments, the second receiving module 701 is configured to receive the system message requested by the terminal on the partial synchronization signal/physical broadcast channel (SS/PBCH) beam according to a direction in which the terminal is located, when receiving the system message requested by the terminal on the partial synchronization signal/physical broadcast channel (SS/PBCH) beam.

In some embodiments, the apparatus further includes a second sending module 700, configured to send a request message on a first beam by the terminal in a connected state, where the request message is used to request the system message.

In some embodiments, the second receiving module 701 is configured to receive the system message requested by the terminal on the partial synchronization signal/physical broadcast channel (SS/PBCH) beam according to a direction of the first beam for the terminal to send the request message, when receiving the system message requested by the terminal on part of the synchronization signal/physical broadcast channel (SS/PBCH) beam.

In some embodiments, the second receiving module 701 is configured to receive the system message requested by the terminal on an SS/PBCH beam having a predetermined type of quasi co-location (QCL) relationship with an uplink reference signal beam corresponding to a physical uplink shared channel (PUSCH) for the terminal to send the request message, when receiving the system message requested by the terminal on the partial synchronization signal/physical broadcast channel (SS/PBCH) beam.

In some embodiments, when receiving the system message requested by the terminal on the partial synchronization signal/physical broadcast channel (SS/PBCH) beam, the second receiving module 701 is configured to at least one of the following:
receive the system message requested by the terminal on an SS/PBCH beam having a predetermined type of quasi co-location (QCL) relationship with a transmission configuration indication (TCI) of a physical downlink control channel (PDCCH) configured for the terminal;
receive the system message requested by the terminal on an SS/PBCH beam having a predetermined type of quasi co-location (QCL) relationship with a transmission configuration indication (TCI) of a PDCCH activated by the terminal; or
receive the system message requested by the terminal on an SS/PBCH beam having a predetermined type of quasi co-location (QCL) relationship with a transmission configuration indication (TCI) of a physical downlink shared channel (PDSCH) configured for the terminal. In some embodiments, the predetermined type of QCL relationship includes a type D of QCL relationship.

In some embodiments, an active bandwidth part (BWP) of the terminal is configured with a common search space for receiving a system message requested on demand.

According to embodiments of the present disclosure, there is provides a communication device, including:
a memory, configured to store an instruction executable by a processor; and
a processor, connected to the memory respectively;
where the processor is configured to perform the method for system message processing provided in any of the foregoing technical solutions.

The processor may include various types of storage medium. The storage medium is a non-transitory computer storage medium. After the communication device is powered down, the information on the storage medium can continue to be memorized and stored.

Here, the communication device includes a terminal or a network element, and the network element may be any one of the foregoing first network element to fourth network element.

The processor may be connected to the memory through a bus or the like, and is configured to read an executable program stored in the memory, for example, to perform at least one of the methods shown in FIG. 2 to FIG. 5.

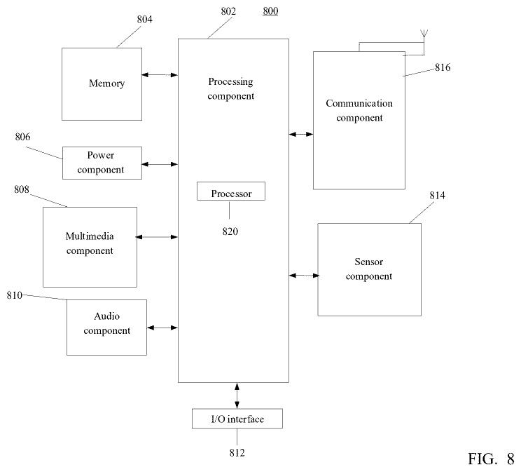

FIG. 8 is a block diagram of a terminal 800 according to some embodiments of the present disclosure. For example, the terminal 800 may be a mobile phone, a computer, a digital broadcast user device, a message transceiving device, a game console, a tablet device, a medical device, a fitness device, a personal digital assistant, or the like.

Referring to FIG. 8, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as operations associated with display, telephone calls, data communications, camera operations, and recording operations. The processing component 802 may include one or more processors 820 to execute instructions to generate all or part of the steps of the above methods. Moreover, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operation of the terminal 800. Examples of such data include instructions of any application or method operating on the terminal 800, contact data, phonebook data, messages, pictures, videos, etc. The memory 804 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the terminal 800. The power component 806 may include a power management system, one or more power supplies, and other components associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touching, sliding, and gestures on the touch panel. The touch sensor may not only sense a boundary of a touching or sliding action, but also detect a duration and pressure associated with the touching or sliding action. In some embodiments, the multimedia component 808 includes a front camera and/or a rear camera. When the terminal 800 is in an operation mode, such as a photographing mode or a video mode, the front camera and/or the rear camera may receive external multimedia data. Each of the front camera and the rear camera may be a fixed optical lens system or have focal length and optical zoom capability. The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and a peripheral interface module, and the peripheral interface module may be a keyboard, a click wheel, a button, or the like. The button may include, but is not limited to, a home button, a volume button, a starting button, or a locking button.

The sensor component 814 includes one or more sensors to provide status assessments of various aspects of the terminal 800. For example, the sensor component 814 may detect an on/off state of the terminal 800, relative positioning of the component, for example, the components are a display and a keypad of the terminal 800. The sensor component 814 may further detect a position change of the terminal 800 or one component of the terminal 800, presence or absence of contact between the user and the terminal 800, an orientation or acceleration/deceleration of the terminal 800, and a temperature change of the terminal 800. The sensor component 814 may include a proximity sensor configured to detect the presence of nearby objects without any physical contact. The sensor component 814 may also include an optics sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as WiFi, 2G, or 3G, or a combination of them. In some embodiments, the communication component 816 receives a broadcast signal or broadcast related information from an external broadcast management system via a broadcast channel. In some embodiments, the communication component 816 further includes a near field communication (NFC) module to facilitate a short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the methods described above.

In some embodiments, there is further provided a non-transitory computer-readable storage medium including an instruction, for example, the memory 804 including an instruction. The instruction may be executed by the processor 820 of the terminal 800 to perform and generate the foregoing methods. For example, the non-transitory computer-readable storage medium may be a ROM, a random access memory (RAM), a CD-ROM, a magnetic tape, a floppy disk, an optical data storage device, or the like.

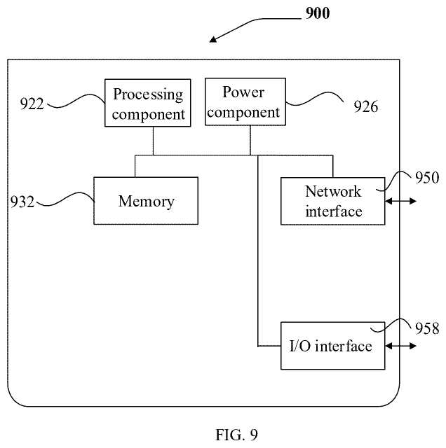

As shown in FIG. 9, an embodiment of the present disclosure shows a structure of an access device. For example, the communication device 900 may be provided as a network side device. The communication device may be various network elements such as the foregoing access network element and/or network function.

Referring to FIG. 9, the communication device 900 includes a processing component 922 that further includes one or more processors, and memory resources represented by the memory 932 for storing an instruction, such as an application, that may be executed by the processing component 922. The application stored in the memory 932 may include one or more modules each corresponding to a set of instructions. In addition, the processing component 922 is configured to execute the instruction to perform any method applied to the access device in the foregoing methods, for example, the method as shown in any one of FIG. 2 to FIG. 5.

The communication device 900 may further include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as Windows Server™, Mac OS X™, Unix™, Linux™, FreeBSD™, or the like.

According to embodiments of the present disclosure, there is provided a method and apparatus for system message processing, a communication device, and a non-transitory computer-readable storage medium.

According to a first aspect of the embodiments of the present disclosure, there is provided a method for system message processing, which is performed by a base station, and the method includes:
sending a system message requested by a terminal on a partial synchronization signal/physical broadcast channel (SS/PBCH) beam.

According to a second aspect of the embodiments of the present disclosure, there is provided a method for system message processing, which is performed by a terminal, and the method includes:
receiving a system message requested by the terminal on a partial SS/PBCH beam.

According to a third aspect of the embodiments of the present disclosure, there is provided an apparatus for system message processing, where the apparatus includes:
a first sending module, configured to send a system message requested by a terminal on a partial SS/PBCH beam.

According to a fourth aspect of the embodiments of the present disclosure, there is provided an apparatus for system message processing, and the apparatus includes:
a second receiving module, configured to receive a system message requested by a terminal on a partial SS/PBCH beam.

According to a fifth aspect of the embodiments of the present disclosure, there is provided a communication device, including a processor, a transceiver, a memory, and an executable program stored in the memory and capable of being run by the processor, where when the processor runs the executable program, the method for system message processing provided in the first aspect or the second aspect is performed.

According to a sixth aspect of the embodiments of the present disclosure, there is provided a computer storage medium, where the computer storage medium stores an executable program; and after the executable program is executed by a processor, the method for system message processing provided in the first aspect or the second aspect is able to be implemented.

According to the technical solutions provided in the embodiments of the present disclosure, the base station only needs to broadcast the requested SI on the SS/PBCH beam in the direction where the terminal is located, and does not need to broadcast the SI in all SS/PBCH beam directions, so that unnecessary broadcast for the requested system message can be reduced, and time-frequency domain resources consumed by the requested system message can be reduced. It is to be understood that both the foregoing general description and the following detailed description are exemplary and explanatory only and are not restrictive of the embodiments of the present disclosure.

Other embodiments of the present disclosure will be apparent to those skilled in the art from consideration of the description and practice of the present disclosure. The present disclosure is intended to cover any variations, uses, or adaptations of the present disclosure following the general principles of the present disclosure and including common general knowledge and conventional technical means in the art not disclosed in the present disclosure. It is intended that the description and embodiments may be considered as examples only, with a true scope and spirit of the present disclosure being indicated by the following claims.

It will be appreciated that the present disclosure is not limited to the precise construction that has been described above and illustrated in the accompanying drawings, and that various modifications and changes may be made without departing from the scope of the present disclosure. It is intended that the scope of the present disclosure be limited only by the appended claims.

1. A method for system message processing, performed by a base station, and the method comprising:
sending a system message requested by a terminal on a partial synchronization signal/physical broadcast channel (SS/PBCH) beam.

2. The method according to claim 1, wherein sending the system message requested by the terminal on the partial synchronization signal/physical broadcast channel (SS/PBCH) beam comprises:
sending the system message requested by the terminal on the partial synchronization signal/physical broadcast channel (SS/PBCH) beam according to a direction in which the terminal is located.

3. The method according to claim 1, wherein the method further comprises:
receiving a request message sent by the terminal in a connected state on a first beam, wherein the request message is used to request the system message.

4. The method according to claim 3, wherein sending the system message requested by the terminal on the partial synchronization signal/physical broadcast channel (SS/PBCH) beam comprises:
sending the system message requested by the terminal on the partial synchronization signal/physical broadcast channel (SS/PBCH) beam according to a direction of the first beam for the terminal to send the request message.

5. The method according to claim 3, wherein sending the system message requested by the terminal on the partial synchronization signal/physical broadcast channel (SS/PBCH) beam comprises at least one of following:
sending the system message requested by the terminal on an SS/PBCH beam having a predetermined type of quasi co-location (QCL) relationship with an uplink reference signal beam corresponding to a physical uplink shared channel (PUSCH) for the terminal to send the request message;
sending the system message requested by the terminal on an SS/PBCH beam having a predetermined type of quasi co-location (QCL) relationship with a transmission configuration indication (TCI) of a physical downlink control channel (PDCCH) configured for the terminal;
sending the system message requested by the terminal on an SS/PBCH beam having a predetermined type of quasi co-location (QCL) relationship with a transmission configuration indication (TCI) of a PDCCH activated by the terminal; or
sending the system message requested by the terminal on an SS/PBCH beam having a predetermined type of quasi co-location (QCL) relationship with a transmission configuration indication (TCI) of a physical downlink shared channel (PDSCH) configured for the terminal.

6. The method according to claim 5, wherein the predetermined type of QCL relationship comprises a type D of QCL relationship.

7. The method according to claim 1, wherein an active bandwidth part (BWP) of the terminal is configured with a common search space for receiving other system information.

8. A method for system message processing, performed by a terminal, and the method comprising:
receiving a system message requested by the terminal on a partial synchronization signal/physical broadcast channel (SS/PBCH) beam.

9. The method according to claim 8, wherein receiving the system message requested by the terminal on the partial synchronization signal/physical broadcast channel (SS/PBCH) beam comprises:
receiving the system message requested by the terminal on the partial synchronization signal/physical broadcast channel (SS/PBCH) beam according to a direction in which the terminal is located.

10. The method according to claim 8, wherein the method further comprises:
sending a request message on a first beam, wherein the terminal is in a connected state, and the request message is used to request the system message.

11. The method according to claim 10, wherein receiving the system message requested by the terminal on the partial synchronization signal/physical broadcast channel (SS/PBCH) beam comprises:
receiving the system message requested by the terminal on the partial synchronization signal/physical broadcast channel (SS/PBCH) beam according to a direction of the first beam for the terminal to send the request message.

12. The method according to claim 10, wherein receiving the system message requested by the terminal on the partial synchronization signal/physical broadcast channel (SS/PBCH) beam comprises at least one of following:
receiving the system message requested by the terminal on an SS/PBCH beam having a predetermined type of quasi co-location (QCL) relationship with an uplink reference signal beam corresponding to a physical uplink shared channel (PUSCH) for the terminal to send the request message;
receiving the system message requested by the terminal on an SS/PBCH beam having a predetermined type of quasi co-location (QCL) relationship with a transmission configuration indication (TCI) of a physical downlink control channel (PDCCH) configured for the terminal;
receiving the system message requested by the terminal on an SS/PBCH beam having a predetermined type of quasi co-location (QCL) relationship with a transmission configuration indication (TCI) of a PDCCH activated by the terminal; or
receiving the system message requested by the terminal on an SS/PBCH beam having a predetermined type of quasi co-location (QCL) relationship with a transmission configuration indication (TCI) of a physical downlink shared channel (PDSCH) configured for the terminal.

13. The method according to claim 12, wherein the predetermined type of QCL relationship comprises a type D of QCL relationship.

14. The method according to claim 8, wherein an active bandwidth part (BWP) of the terminal is configured with a common search space for receiving a system message requested on demand.

15-28. (canceled)

29. A communication device, comprising a processor, a transceiver, a memory, and an executable program stored in the memory and capable of being run by the processor, wherein when the processor runs the executable program, a method for system message processing is performed, and the method comprises:
sending a system message requested by a terminal on a partial synchronization signal/physical broadcast channel (SS/PBCH) beam.

30. A non-transitory computer-readable storage medium, wherein the non-transitory computer-readable storage medium stores an executable program, and after the executable program is executed by a processor, the method provided according to claim 1 is able to be implemented.

31. The method according to claim 2, wherein the method further comprises:
receiving a request message sent by the terminal in a connected state on a first beam, wherein the request message is used to request the system message.

32. The method according to claim 9, wherein the method further comprises:
sending a request message on a first beam, wherein the terminal is in a connected state, and the request message is used to request the system message.

33. A communication device, comprising a processor, a transceiver, a memory, and an executable program stored in the memory and capable of being run by the processor, wherein when the processor runs the executable program, the method provided according to claim 8 is performed.

34. A non-transitory computer-readable storage medium, wherein the non-transitory computer-readable storage medium stores an executable program, and after the executable program is executed by a processor, the method provided according to claim 8 is able to be implemented.
